(19) United States
(12) Patent Application Publication
(10) Pub. No.: US 2008/0080584 A1
(43) Pub. Date: Apr. 3, 2008

(54) SOLID-STATE LASER GAIN MODULE

(75) Inventor: Donald B. Coyle, Ellicott City, MD (US)

Correspondence Address: NASA GODDARD SPACE FLIGHT CENTER, 8800 GREENBELT ROAD, MAIL CODE 140.1, GREENBELT, MD, 20771, US

(73) Assignee: USA of America as represented by the Administrator of the National Aeronautics & Space Adm., Washington, DC (US)

(21) Appl. No.: 11/537,051

(22) Filed: Sep. 29, 2006

(51) Int. Cl. H01S 3/08

(52) U.S. Cl. 372/92

(57) ABSTRACT

A laser gain module comprises a spoiled hexagonal shaped slab for receiving a laser beam. The laser beam enters the slab on one face and is reflected internally at one or more faces. The laser beam propagates through the slab and may be amplified with each reflection. The laser gain module also comprises two opposing non-parallel sides that are elongated in comparison to the remaining four sides thus creating the spoiled hexagon geometry. The module may also include two or four laser diode arrays positioned so as to constitute a side pumping arrangement to provide additional energy to the laser gain module. The additional energy provided to the laser gain module may result in greater amplification of the laser beam as it propagates through the laser gain module.

### ORIGIN OF THE INVENTION

The invention described herein was made by an employee of the United States Government, and may be manufactured and used by or for the Government for governmental purposes without the payment of any royalties thereon or therefor.

### FIELD OF THE INVENTION

The present invention relates generally to optical amplifiers, and in particular to a diode pumped neodymium yttrium aluminum garnet (Nd:YAG) solid-state slab laser gain module.

### BACKGROUND

Achieving the maximum laser energy from the smallest possible laser system is an ongoing challenge in the design of laser systems. Large complicated laser systems have been employed to achieve the desired laser gain and efficiencies. Elaborate and often complex laser reflecting schemes and different laser gain media are often used in the effort to achieve greater laser system efficiency. One type of laser gain medium used by those skilled in the art includes the solid-state laser medium. Laser amplifiers operate by passing a laser beam through the solid-state laser medium one or more times. Solid-state slab laser gain modules typically comprise a housing that includes a solid-state laser gain material. The laser gain material may be a crystal. Laser gain materials such as Nd:YAG, neodymium glass, (Nd:Glass), and Ti:Sapphire may be used. The Nd:YAG medium may also be attractive to those skilled in the art due to its inherent ruggedness, thermal and mechanical properties and scalability. However, many of the systems employing Nd:YAG as a laser gain material achieve optical efficiencies of only 1-2%.

Diode pumped solid-state lasers may be employed in attempts to further increase laser efficiencies. Diode pumping results in enhanced electrical-to-optical system efficiency since diode lasers emit optical energy over a narrow spectrum that closely matches the solid-state absorption profiles. Thus, the diode pumped lasers may provide a closer match of the absorption peak of the laser gain medium than a laser utilizing a broadband lamp. The improved wavelength match increases the efficiency of the solid-state laser gain module. The diode pumped source may be a single emitter or an array. End pumped or side pumped laser diode arrays may be used.

In a solid-state laser gain module, electromagnetic radiation emitted by the pumping source, of a specific wavelength, impinges upon the major side faces of the laser gain and is absorbed by the medium as it traverses through the material which excites the active species to create a population inversion. The interaction of an externally injected laser beam, of a specific longer wavelength, with the excited ions in the gain medium amplifies the beam. As this beam traverses the medium, the photon's electric field triggers the decay of the excited ions, or inversions, and their release of energy match the wavelength of the inserted beam, thus achieving gain. The laser can be passed generally along the longitudinal axis of the gain module by multiple internal zig-zag reflections, which produces longer path lengths inside the medium than a simple central path, from the side faces of the gain module. The laser is thus amplified each time it passes through the gain module until the stored energy is depleted or naturally decays on it's own.

The harsh environment and high cost of space based laser systems demand that every effort be made to achieve maximum efficiencies from these systems. The smallest efficiency gain may result in extensive mass and size reduction that translate into extensive cost savings in a spacecraft. Thus, those skilled in the art expend great effort to increase efficiencies of such laser systems. Increasing the laser amplification via laser gain modules is part of that effort. For reasons stated herein, there may be a need in the art to provide more efficient laser gain modules in order to increase the efficiency of laser systems.

### SUMMARY OF THE INVENTION

In one embodiment, the invention may be characterized as a laser device consisting of a gain module wherein the gain module includes a spoiled hexagonal shaped slab for receiving a laser beam. The laser beam enters the slab on one face and is reflected internally at one or more faces. The laser beam propagates through the slab with each reflection. The laser beam is also intensified as it propagates through the slab. The laser beam may enter and exit the slab at different locations. This design creates the longest gain path per gain region area without the need for external beam folding and alignment optics than any known amplifier design published to date.

In another embodiment, the invention may be characterized as a laser system that comprises a laser gain module that includes a “spoiled” hexagonal shaped slab wherein two opposing non-parallel sides of the slab are elongated in comparison to the remaining four sides. (A “spoiled” hexagon describes a hexagon with 3 pairs of equal faces, yet each face is a different length than either adjacent face.) The elongated sides of the slab are also tapered so as to create an angle of approximately 1 degree along the elongated sides. The system may also include up to four laser diode arrays, possibly more for very high power systems, so as to provide additional power to the laser gain module. The additional power provided to the laser gain module may result in greater amplification of the laser beam as it propagates through the laser gain module.

In yet another embodiment, the invention may be characterized as a method of amplifying a laser beam that comprises the steps of providing a spoiled hexagonal shaped Nd:YAG crystal slab for amplifying the intensity of a laser beam and directing the laser beam to a side face of the crystal so as to produce a beam that is repeatedly reflected within the crystal such that the angle of incidence of each successive reflected beam is decreased to a point certain within the crystal. Once the point certain within the crystal is reached by the beam, it is then reflected such that the angle of incidence of each successive reflected beam is increased until the beam reaches another point certain within the crystal.

A laser gain device, system and method of varying scope are described herein. In addition to the aspects and advantages described in this summary, further aspects and advantages will become apparent by reference to the drawings and the detailed description that follows.

### BRIEF DESCRIPTION OF THE DRAWING

FIG. 1 shows a laser gain module with the laser beam path depicted therein in accordance with an embodiment of the present invention.

FIG. 2 shows a laser gain module with an optical raytrace demonstrating the extensive fill factor in the pumped region of the module, in accordance with an embodiment of the present invention.

FIG. 3 shows an isometric view of the laser gain module shown in FIGS. 1 and 2 in accordance with an embodiment of the present invention.

FIG. 4 shows a laser system in a 2-pass configuration with polarization manipulating optics in accordance with an embodiment of the present invention.

### DETAILED DESCRIPTION

In the following detailed description, reference is made to the accompanying drawings that form a part hereof, and in which are shown, by way of illustration, specific embodiments, which may be practiced. These embodiments are described in sufficient detail to enable those skilled in the art to practice the embodiments. Those skilled in the art will readily understand that other embodiments may be utilized, and that logical, mechanical, electrical and other changes may be made, without departing from the scope of the embodiments. Ranges of parameter values described herein are understood to include all sub-ranges falling therewithin. The following detailed description may, therefore, not to be taken in a limiting sense but as illustrative of the embodiments of the present invention.

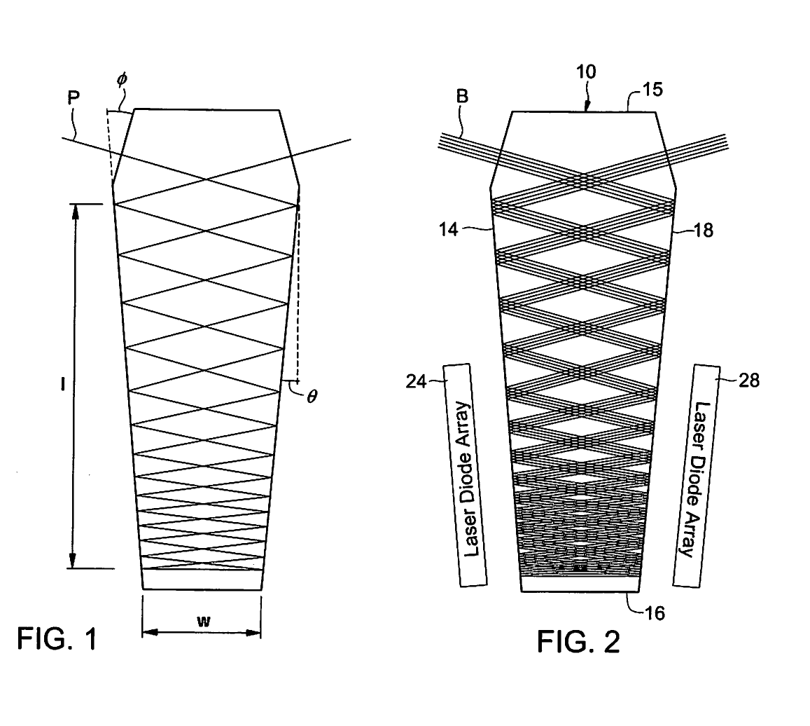

FIG. 1 shows a laser gain module 10 that includes a spoiled hexagonal or coffin shape. The laser gain module 10 may be of a crystal such as neodymium yttrium aluminum garnet (Nd:YAG) which emits a wavelength of 1064 nm. Other crystals such as Nd:Glass and Ti:Sapphire may also be suitable. Laser gain module 10 includes input/output sides 12, 20, elongated opposing non-parallel sides 14, 18, top side 15, bottom side 16, front face 11 and a back face (not shown) which may be parallel to front face 11. Front face 11 and back face (not shown) include a mechanical finish for bonding, heat removal and minimal internal reflectance for minimizing amplified spontaneous emission (ASE). Laser gain module 10 also include a length l and width w. Input/output sides 12, 20 are tapered at angle Ø. Taper angle Ø may be about 22° or any suitable angle that may produce an incident angle that may be 0°-23°. Opposing sides 14, 18 may be coated with a reflective coating. The reflective coating may be highly reflective at about 1064 nm over 0°-23° incident angles, and concomitantly highly transmissive at the pump wavelength of about 809 nm. Due to the high number of bounces, a 99.5% reflective coating will produce a 28 bounce single pass loss of about 13%. A high reflector (HR) tolerance of about 0.1% or less may be needed with little incident angle sensitivity while maintaining acceptable antireflection (AR) performance for about 809 nm pumped light energy. The importance of the AR pump light however may be secondary to the 1064 nm HR coating specification because a relatively large (1%) loss in AR is far less significant for the total usable gain than a 0.1% per bounce in HR coating performance. Elongated opposing non-parallel sides 14, 18 are tapered at an angle θ. The wedge angle θ of sides 14, 18 may be selected so as to allow a laser beam B passing through input side 12 to travel a length l of module 10 before laser beam B reverses course thus effectively producing a “double pass” path. Path P depicts the “double pass” path profile that beam B may follow as a result of an angle of incidence normal to input side 12. Wedge angle θ may be determined through an iterative modeling process with the requirement of obtaining the maximum path length for laser beam B that would match the initial scale of about a 1064 nm beam size. Generally a smaller value of O may provide more passes across the width w of gain module 10. Note that the width w decreases slightly as the length l approaches the bottom side 16. The width w may have a minimum dimension that is about ⅕ the length l to guarantee little unabsorbed pumped energy reaches an opposing diode array.

FIG. 2 shows the laser gain module of FIG. 1 with an optical raytrace or beam B demonstrating the extensive fill factor in a pumped region of gain module 10. The radiation source for pumping the laser gain module 10 comprises a plurality of diode lasers formed in an array. Laser diode arrays 22, 24, 26 and 28 (note that only diode arrays 24 and 28 are shown in FIG. 2) positioned on opposites sides of laser gain module 10 may constitute a side pumped arrangement. Thus, four laser diode arrays with 3 bars per array may be utilized in one embodiment of the present invention. The radiation output of the diode laser arrays 24 and 28 may be accurately tuned to the absorption line of the active species in laser gain module 10 to achieve a high pumping efficiency and to minimize detrimental heating effects. Laser diode arrays 24 and 28 may emit radiation at the wavelength of about 809 nm to pump laser gain module 10. Laser gain module 10 re-emits a laser output at a wavelength of about 1064 nm. The portion of laser gain module 10 affected by the laser diode arrays may be considered the pumped region.

The optical pumped radiation produced by the diode arrays 24 and 28 enters laser gain module 10 via side surfaces 14 and 18 from which laser beam B will be reflected. As a result of the coating that may be applied to laser gain module 10, side surfaces 14 and 18 may be highly transmissive for about 809 nm pumped radiation provided by laser diode arrays 24 and 28 while highly reflective for an about 1064 nm laser beam B propagated within laser gain module 10. The pumped radiation may enter side surfaces 14 and 18 at near normal incidence. Laser beam B enters input surface 12 at near normal incidence and passes through laser gain module 10 until beam B reaches side surface 18 at which point laser beam B may be reflected towards side surface 14 where laser beam B is reflected once again toward side surface 18. This pattern of reflecting or bouncing laser beam B from side surface 14 to side surface 18 and back again may be repeated as laser beam B propagates through laser gain module 10 thus creating a zig-zag path pattern generally depicted as P.

In one embodiment, as laser beam B propagates through laser gain module 10, the angle of reflectance decreases each time laser beam B bounces between side surfaces 14 and 18 as laser beam B approaches end surface 16. This consistent decrease in the angle of reflectance may be a result of the wedge or tapered angle θ of side surfaces 14 and 18. The reflectance angle will continue to decrease until beam B reaches a certain point defined by length l along laser gain module 10. At this point, laser beam B may be reflected in the opposite direction as a result of the spoiled hexagonal geometry of laser gain module 10. Laser beam B now propagates through laser gain module 10 in the opposite direction towards output surface 20. The angle of reflectance now increases each time laser beam B bounces between side surfaces 14 and 18 as the beam approaches output surface 20. The innovative wedge shape of laser gain module 10 causes the angle of reflection of laser beam B to decrease as it approaches end surface 16 of laser gain module 10. The innovative wedge shape also causes the reflection angle of laser beam B to increase as it approaches output surface 20 of laser gain module 10.

Laser diode arrays 24 and 28 may be provided in a side pumped configuration as shown in FIG. 2. The side pumping configuration enables the pumping of laser gain module 10 with much higher power levels than an end pumping configuration can provide. The higher power levels mainly result from the diode pump power being distributed over a larger surface-area of laser gain module 10 than a traditional end-pumping configuration. The slab geometry of laser gain module 10 may provide for heat removal from the laser medium such that a thermal gradient established by the heat removal occurs primarily in one direction. This configuration allows a linearly polarized laser beam to be amplified in the laser active slab, with the polarization of the laser beam either parallel or perpendicular to the thermal gradient, and without objectionable effects due to thermal stress-induced birefringence. Laser beam B increases in intensity as it propagates through the pumped region of laser gain module 10. Diode pumped energy is directed into laser gain module 10 through side surfaces 14 and 18, which may be configured for reflecting the amplified beam B. In the present invention, diode pumping results in enhanced electrical-to-optical system efficiency because the diode lasers 24 and 28 emit optical energy over a narrow band that closely matches the solid-state absorption profile of laser gain module 10. A zig-zag path taken by beam B helps to average out, or mitigate, spatial distortion effects on the beam profile that pump-induced non-uniformities in the slab may have. The pumped region contains stored energy provided by laser diode arrays 24 and 28 thereby amplifying laser beam B as it passes through the pumped region of laser gain module 10. The stored energy in the pumped region enters through side surfaces 14 and 16 from side pumped laser diode arrays 24 and 28. The wedge shaped configuration of laser gain module 10 facilitates the zig-zag path profile P of laser beam B. The fact that side surfaces 14 and 18 are coated so as to be highly reflective of light energy that may be approximately 1064 nm wavelength while allowing light energy that may be approximately 809 nm wavelength to pass creates a scenario wherein laser beam B is reflected and amplified as it traverses laser gain module 10.

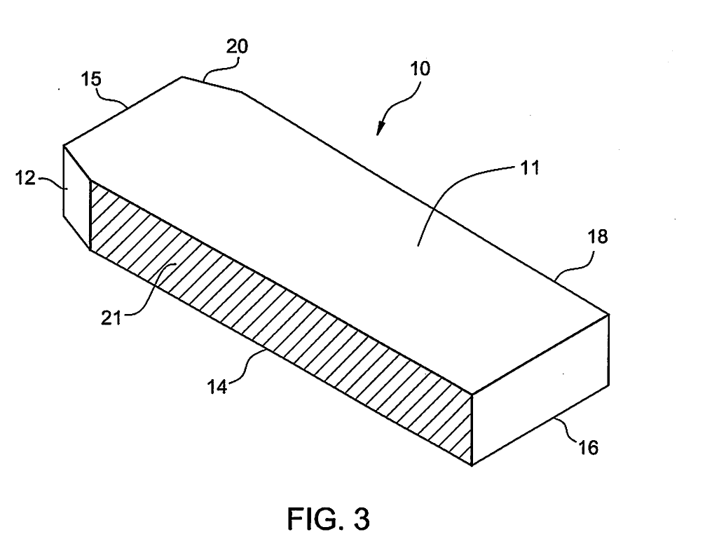

FIG. 3 shows an isometric view of the laser gain module 10. Side surfaces 14 and 18 are coated with a reflective material 21. Reflective material 21 may be highly reflective for light energy that is approximately 1064 nm wavelength. Reflective material 21 is not reflective of light energy that is approximately in the 809 nm wavelength range. This arrangement allows laser beam B to simultaneously be pumped by laser diode arrays 24 and 28 while being reflected by side surfaces 14 and 18 of laser gain module 10 because laser diode arrays 24 and 28 emit light energy that is 809 nm wavelength. The juxtaposition of laser diode arrays 24 and 28 with side faces 14 and 18 respectively allows the light energy emitted by the laser diodes to pass through side faces 14 and 18 thereby pumping laser gain module 10 so as to increase the amplification of laser beam B as it propagates through laser gain module 10.

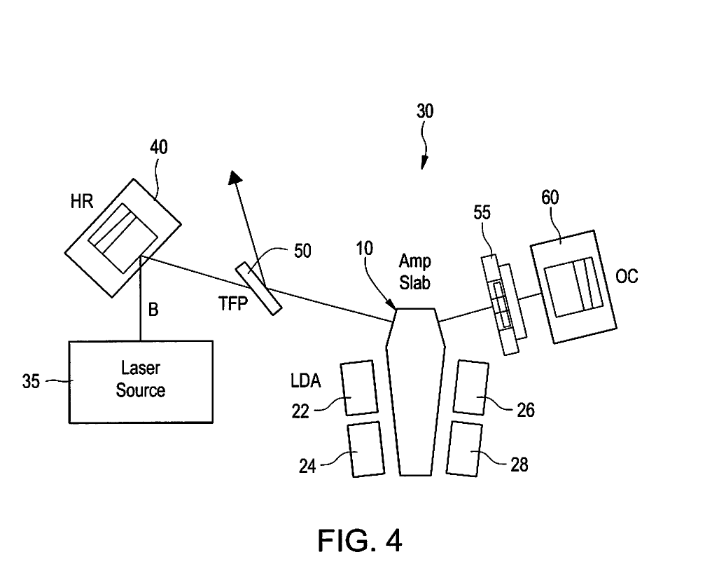

FIG. 4 shows a laser system 30 that comprises an alternate embodiment of laser gain module 10. Laser gain module 10 includes four laser diode arrays 22, 24, 26 and 28. This arrangement illustrates the flexibility of being able to increase the pumped region of laser gain module 10 thereby further increasing the amplification of laser beam B as it propagates through laser gain module 10. The increase in energy provided to laser gain module 10 via laser diode arrays 22 and 26 may result in an increase in the number of bounces/reflections experienced by laser beam B as it propagates through laser gain module 10. The increase in the number of bounces may result in an alternate path P′ (not shown) that laser beam B follows as it traverses laser gain module 10. The path is changed because the number of bounces experienced by laser beam B increases as a result of the positioning of additional laser diode arrays 22 and 26. The new path P′ (not shown) also follows a path wherein the angle of reflection decreases with each bounce/reflection experienced by laser beam B as it approaches end surface 16 of laser gain module 10. Once laser beam B reaches a certain point defined by length l, laser beam B will reverse its path and propagate in the opposite direction within laser gain module 10 until laser beam B reaches output face 20 and exits laser gain module 10.

In operation, a laser beam B may be initiated via a source 35. Laser beam B may be directed towards a high reflector module 40 which directs laser beam B through a thin film polarizer 50 which further directs beam B to input face 12 of laser gain module 10. Once beam B enters gain module 10 approximately orthogonal to input surface 12, beam B may be directed to side surface 18 where it may then be reflected onto side surface 14 and reflected back to side surface 18. This pattern of reflection will continue as laser beam B traverses laser gain module 10 until beam B reaches a point defined by length l along laser gain module 10. The angle of reflection will decrease with each bounce of laser beam B as it approaches end surface 16 of laser gain module 10. Once laser beam B reaches length l, the beam may be reflected in a path that propagates towards output surface 20. The angle of reflection of laser beam B will now increase with each reflection/bounce from side surfaces 14 and 18 until it reaches output surface 20. Laser beam B may exit output surface 20 approximately orthogonal to output surface 20. Once laser beam B exits output surface 20, laser beam B is directed towards ¼ wave-plate 55. Laser beam B may then be directed to output coupler 60 where it may be directed at will.

One of skill in the art will readily appreciate that the names or labels of the elements are not intended to limit embodiments. Furthermore, additional processes and apparatus can be added to the components, functions can be rearranged among the components, and new components to correspond to future enhancements and physical devices used in embodiments can be introduced without departing from the scope of embodiments. One of skill in the art will readily recognize that embodiments are applicable to future communication devices, different file systems, and new data types. The terminology used in this disclosure is meant to include all alternate technologies that may provide the same functionality as described herein.

What is claimed is:

1. A laser gain module comprising:
an input surface;
a first side surface connected to said input surface;
an output surface;
a second side surface connected to said output surface; and,
an end surface connected to said first and second side surfaces wherein said first and second side surfaces are non-parallel.

2. The device of claim 1, further comprising a top surface connecting said input and output surfaces.

3. The device of claim 2, wherein said end surface and said top surface are parallel.

4. The device of claim 2, wherein said first and second side surfaces are non-parallel.

5. The device of claim 4, wherein said first and second side surfaces are longer than said end surface.

6. The device of claim 4, wherein said first and second side surfaces form a wedge angle with respect to said end surface.

7. The device of claim 2, wherein said first and second side surfaces comprise a reflective coating.

8. The device of claim 7, wherein said reflective coating is highly reflective of light energy that is about 1064 nm.

9. The device of claim 7, wherein said reflective coating is transmissive for the light energy that is about 809 nm.

10. The device of claim 2, wherein said laser gain module is a crystal.

11. The device of claim 10, wherein said crystal comprises a member of the group consisting of: Nd:YAG, Nd:Glass and Ti:Sapphire.

12. The device of claim 2, wherein said input surface and said output surface are non-parallel.

13. The device of claim 12, wherein a cross-section of said module is a spoiled hexagon.

14. The device of claim 4, further comprising a first laser diode array adjacent and substantially parallel to said first side surface.

15. The device of claim 4, further comprising a second laser diode array adjacent and substantially parallel to said second side surface.

16. A solid-state laser gain crystal comprising:
non-parallel input and output surfaces;
non-parallel first and second side surfaces connected to said input and said output surfaces respectively; and,
parallel top and end surfaces connected to said input and said first and second side surfaces respectively, wherein a cross-section of said crystal is a spoiled hexagon.

17. The device of claim 16, wherein said first and second side surfaces comprise a reflective coating.

18. The device of claim 17, wherein said reflective coating is highly reflective of light energy that is about 1064 nm and is transmissive for the light energy that is about 809 nm.

19. The device of claim 16, wherein said crystal comprises a material of the member of a group consisting of: Nd:YAG, Nd:Glass and Ti:Sapphire.

20. The device of claim 18, further comprising a first laser diode array adjacent and substantially parallel to said first side surface.

21. The device of claim 18, further comprising a second laser diode array adjacent and substantially parallel to said second side surface.

22. A laser system comprising:
a laser source for generating a laser beam;
a high reflector;
a thin film polarizer;
a laser gain crystal that comprises a spoiled hexagon geometry;
a first pair of laser diode arrays; and
an output coupler.

23. The laser system of claim 22, wherein the laser source directs the laser beam towards said high reflector and through said thin film polarizer.

24. The laser system of claim 23, wherein said laser beam is further directed towards an input surface of said laser gain crystal.

25. The laser system of claim 24, wherein said laser beam makes a zig-zag path within said laser gain crystal.

26. The laser system of claim 22, wherein said laser gain crystal further comprises non-parallel side surfaces.

27. The laser system of claim 26, wherein said non-parallel side surfaces comprise a reflective coating.

28. The laser system of claim 27, wherein said reflective coating is highly reflective of light energy that is about 1064 nm.

29. The laser system of claim 27, wherein said reflective coating is transmissive for the light energy that is about 809 nm.

30. The laser system of claim 22 comprising a second pair of laser diode arrays.

31. The laser system of claim 30, wherein said second pair of laser diode arrays is adjacent to said first pair of laser diode arrays.

32. The laser system of claim 22, wherein said first pair of laser diode arrays are positioned so as to constitute a side pumping arrangement.

33. The laser system of claim 22, wherein said laser gain crystal comprises a material of the member of a group consisting of: Nd:YAG, Nd:Glass and Ti:Sapphire.

34. A method for amplifying a laser beam comprising the steps of:
reflecting a laser beam from a laser source off a high reflector;
directing said laser beam through a thin film polarizer and towards a laser gain crystal that comprises a spoiled hexagon geometry;
directing said laser beam to an input surface of said laser gain crystal;
causing said laser beam to be reflected off a first side surface and a second side surface of said laser gain crystal;
causing said laser beam to make a zig-zag double pass through said laser gain crystal; and
causing said laser beam to exit said laser gain crystal.

35. The method of claim 34, wherein said first and second side surfaces are non-parallel.

36. The method of claim 35, wherein said non-parallel side surfaces comprise a reflective coating.

37. The method of claim 36, wherein said reflective coating is highly reflective of light energy that is about 1064 nm.

38. The method of claim 36, wherein said reflective coating is transmissive for the light energy that is about 809 nm.

39. The method of claim 34 further comprising providing a first pair of laser diode arrays adjacent said laser gain crystal.

40. The method of claim 39 further comprising providing a second pair of laser diode arrays adjacent said laser gain crystal.

41. The method of claim 34, wherein said first pair of laser diode arrays are positioned so as to constitute a side pumping arrangement.

42. The method of claim 34, wherein said laser gain crystal comprises a material of the member of a group consisting of: Nd:YAG, Nd:Glass and Ti:Sapphire.

43. The method of claim 34, wherein said laser beam enters said laser gain crystal approximately normal to said input surface.
